(19) United States
(12) Patent Application Publication
(10) Pub. No.: US 2018/0187617 A1
(43) Pub. Date: Jul. 5, 2018

(54) CONTROLLING EXHAUST GAS RECIRCULATION THROUGH MULTIPLE PATHS IN A TURBOCHARGED ENGINE SYSTEM

(71) Applicant: BorgWarner Inc., Auburn Hills, MI (US)

(72) Inventors: John Shutty, Clarkston, MI (US); Houcine Ben Bechir Benali, Braunschweig (DE)

(21) Appl. No.: 15/895,713

(22) Filed: Feb. 13, 2018

Related U.S. Application Data
(63) Continuation of application No. 12/995,592, filed on Dec. 1, 2010, now abandoned.
(60) Provisional application No. 61/057,900, filed on Jun. 2, 2008.

(51) Int. Cl. F02D 41/00; F02M 26/05; F02M 26/06; F02M 26/24; F02D 41/14; F02D 13/02; F02B 29/04; F02M 26/71; F02M 26/48; F02M 26/16; F02M 26/15; F02M 26/10; F02M 26/01

(52) U.S. Cl. CPC F02D 41/0065; Y02T 10/144; F02M 26/06; F02D 41/0007; F02M 26/24; F02D 2041/141; F02D 41/006; F02D 13/0207; F02B 29/0406; F02M 26/71; F02M 26/48; F02M 26/16; F02M 26/15; F02M 26/10; F02D 2041/1431; F02D 2200/0402; F02M 26/01; Y02T 10/47; F02M 26/05

(57) ABSTRACT

A method of controlling exhaust gas recirculation (EGR) in a turbocharged engine system including multiple EGR paths to account for at least one of system constraints, or dead time and/or lag time associated with at least one of the EGR paths.

This application claims the benefit of U.S. Provisional Application No. 61/057,900 filed on Jun. 2, 2008.

### TECHNICAL FIELD

The field to which the disclosure generally relates includes controlling exhaust gas recirculation in turbocharged engine systems.

### BACKGROUND

Turbocharged engine systems include engines having combustion chambers for combusting air and fuel for conversion into mechanical power, air induction subsystems for conveying induction gases to the combustion chambers, and engine exhaust subsystems. The exhaust subsystems typically carry exhaust gases away from the engine combustion chambers, muffle engine exhaust noise, and reduce exhaust gas particulates and oxides of nitrogen (NOx), which increase as engine combustion temperatures increase. Exhaust gas is often recirculated out of the exhaust gas subsystem, into the induction subsystem for mixture with fresh air, and back to the engine. Exhaust gas recirculation (EGR) increases the amount of inert gas and concomitantly reduces oxygen in the induction gases, thereby reducing engine combustion temperatures and, thus, reducing NOx formation. Hybrid EGR systems include multiple EGR paths, for example, a high pressure path on one side of the turbocharger between the turbocharger and the engine, and a low pressure path on the other side of the turbocharger.

### SUMMARY OF EXEMPLARY EMBODIMENTS

One exemplary embodiment of a method includes controlling exhaust gas recirculation (EGR) in a turbocharged engine system including a first EGR path and a second EGR path. The method includes providing first and second EGR setpoints, which are associated with the first and second EGR paths and contribute to a total EGR setpoint. The method also includes applying a transfer function to at least one of the first and second EGR setpoints to account for at least one of dead time or lag time associated with the second EGR path.

A further exemplary embodiment of a method includes controlling exhaust gas recirculation (EGR) in a turbocharged engine system including a first EGR path and a second EGR path. The method also comprises:

a) determining first and second EGR actuator commands corresponding to base first and second EGR setpoints;

b) applying system constraints to the first and second EGR actuator commands to produce constrained first and second EGR actuator commands;

c) determining updated first and second EGR setpoints corresponding to the constrained first and second EGR actuator commands;

d) comparing the first EGR setpoint to the updated first EGR setpoint; and

e) adjusting the base second EGR setpoint in response to the comparison of step d) to produce an adjusted second EGR setpoint.

An additional exemplary embodiment of a method includes controlling exhaust gas recirculation (EGR) in a turbocharged engine system including a first EGR path and a second EGR path. The method also comprises:

a) establishing base first and second EGR setpoints;

b) applying system constraints to the base first and second EGR setpoints to produce constrained first and second EGR setpoints;

c) determining first and second EGR actuator commands from the constrained first and second EGR setpoints;

d) determining updated first and second EGR setpoints corresponding to the determined first and second EGR actuator commands;

e) comparing the first EGR setpoint to the updated first EGR setpoint; and

f) adjusting the base second EGR setpoint in response to the comparison of step e) to produce an adjusted second EGR setpoint.

Another exemplary embodiment of a method includes controlling exhaust gas recirculation (EGR) in a turbocharged engine system including a high pressure (HP) EGR path and a low pressure (LP) EGR path. The method also comprises:

a) establishing base HP and LP EGR setpoints, which are associated with the first and second EGR paths and contribute to a total EGR setpoint;

b) applying system constraints to at least one of the base HP and LP EGR setpoints of step a) or the adjusted HP and LP EGR setpoints from step h) to produce constrained HP and LP EGR setpoints;

c) determining HP and LP EGR actuator commands corresponding to at least one of the base HP and LP EGR setpoints established in step a), the constrained HP and LP EGR setpoints of step b), or the adjusted HP and LP EGR setpoints from step h);

d) applying respective actuator limits to the HP and LP EGR actuator commands determined in step c) to produce updated HP and LP EGR actuator commands;

e) determining updated HP and LP EGR setpoints corresponding to the updated HP and LP EGR actuator commands from step d);

f) applying a transfer function to the updated LP EGR setpoint from step e) to produce a modified LP EGR setpoint;

g) comparing the updated HP and modified LP EGR setpoints to the base HP and LP EGR setpoints from step a); and

h) adjusting the base HP and LP EGR setpoints based on the comparison from step g) to generate adjusted HP and LP EGR setpoints.

Other exemplary embodiments will become apparent from the detailed description provided hereinafter. It should be understood that the detailed description and specific examples, while disclosing exemplary embodiments, are intended for purposes of illustration only and are not intended to limit the scope of the claims.

### BRIEF DESCRIPTION OF THE DRAWINGS

Exemplary embodiments will become more fully understood from the detailed description and the accompanying drawings, wherein:

FIG. 1 is a schematic view of an exemplary embodiment of an engine system including an exemplary control subsystem;

FIG. 2 is a block diagram of the exemplary control subsystem of the engine system of FIG. 1;

FIG. 3 is a flow chart of an exemplary method of EGR control that may be used with the engine system of FIG. 1;

FIG. 4 is a block diagram illustrating an exemplary control flow that may be used with the method of FIG. 3;

FIG. 5 is a block diagram of an exemplary LP EGR transfer function that may be used with the method of FIG. 3;

FIG. 6 is a block diagram of an exemplary HP EGR transfer function that may be used with the method of FIG. 3;

FIG. 7 is a block diagram of an exemplary system transfer function that may be derived from the transfer functions of FIGS. 5 and 6 and used with the method of FIG. 3 and in the control flow of FIG. 4;

FIGS. 8A-8D are graphical plots illustrating EGR setpoints, actuator commands, and actual EGR values, according to a prior art control scheme involving a sudden increase in total EGR fraction;

FIGS. 9A-9D are graphical plots illustrating EGR setpoints, actuator commands, and actual EGR values, according to the method of FIG. 3 and the control flow of FIG. 4 involving a sudden increase in total EGR fraction;

FIGS. 10A-10D are graphical plots illustrating EGR setpoints, actuator commands, and actual EGR values, according to a prior art control scheme involving a temporary decrease in HP EGR contribution; and

FIGS. 11A-11D are graphical plots illustrating EGR setpoints, actuator commands, and actual EGR values, according to the method of FIG. 3 and the control flow of FIG. 4 involving a temporary decrease in HP EGR contribution.

### DETAILED DESCRIPTION OF EXEMPLARY EMBODIMENTS

The following description of the exemplary embodiments is merely exemplary in nature and is in no way intended to limit the invention, its application, or uses.

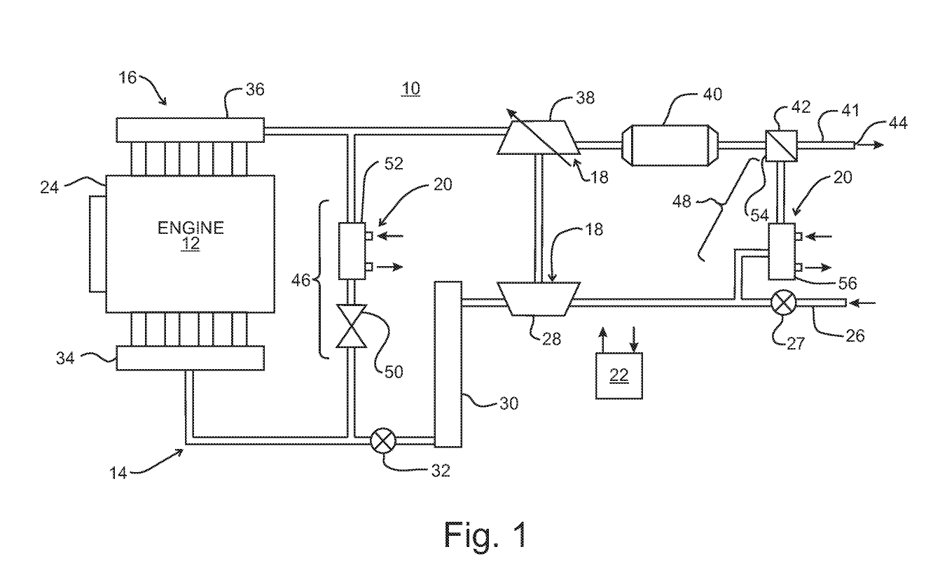

An exemplary operating environment is illustrated in FIG. 1, and may be used to implement presently disclosed methods of controlling multiple path exhaust gas recirculation. In general, the methods may include controlling flow of exhaust gas through multiple individual EGR paths, for example, primarily to maintain a total EGR fraction at a desired level, and secondarily to maintain desired flow levels through the individual EGR paths. Also, the methods may involve rebalancing flow amongst the individual EGR paths to account for transport delays in one or more of the paths and/or any actual or imposed limits of flow through the paths.

An exemplary operating environment is illustrated in FIG. 1, and may be used to implement presently disclosed exemplary methods of EGR control. The methods may be carried out using any suitable system, for example, in conjunction with an engine system such as system 10. The following system description simply provides a brief overview of one exemplary engine system, but other systems and components not shown here could also support the presently disclosed exemplary methods.

In general, the system 10 may include an internal combustion engine 12 to develop mechanical power from internal combustion of a mixture of fuel and induction gases, an induction subsystem 14 to generally provide the induction gases to the engine 12 and, an exhaust subsystem 16 to convey combustion gases generally away from the engine 12. As used herein, the phrase induction gases may include fresh air and recirculated exhaust gases. The system 10 also generally may include a turbocharger 18 in communication across the exhaust and induction subsystems 14, 16 to compress inlet air to improve combustion and thereby increase engine output.

The system 10 further generally may include an exhaust gas recirculation subsystem 20 across the exhaust and induction subsystems 14, 16 to recirculate exhaust gases for mixture with fresh air to improve emissions performance of the engine system 10. The system 10 further generally may include a control subsystem 22 to control operation of the engine system 10. Those skilled in the art will recognize that a fuel subsystem (not shown) is used to provide any suitable liquid and/or gaseous fuel to the engine 12 for combustion therein with the induction gases.

The internal combustion engine 12 may be any suitable type of engine, such as a gasoline engine, or an autoignition or compression-ignition engine like a diesel engine. The engine 12 may include a block 24 with cylinders and pistons therein (not separately shown), which along with a cylinder head (also not separately shown), define combustion chambers (not shown) for internal combustion of a mixture of fuel and induction gases.

The induction subsystem 14 may include, in addition to suitable conduit and connectors, an inlet end 26 which may have an air filter (not shown) to filter incoming air, an intake throttle valve 27 to control EGR, and a turbocharger compressor 28 downstream of the inlet end 26 to compress the inlet air. The induction subsystem 14 may also include a charge air cooler 30 downstream of the turbocharger compressor 28 to cool the compressed air, and an intake throttle valve 32 downstream of the charge air cooler 30 to throttle the flow of the cooled air to the engine 12. The induction subsystem 14 also may include an intake manifold 34 downstream of the throttle valve 32 and upstream of the engine 12, to receive the throttled air and distribute it to the engine combustion chambers.

The exhaust subsystem 16 may include, in addition to suitable conduit and connectors, an exhaust manifold 36 to collect exhaust gases from the combustion chambers of the engine 12 and convey them downstream to the rest of the exhaust subsystem 16. The exhaust subsystem 16 also may include a turbocharger turbine 38 in downstream communication with the exhaust manifold 36. The turbocharger 18 may be a variable turbine geometry (VTG) type of turbocharger, a dual stage turbocharger, or a turbocharger with a wastegate or bypass device, or the like. In any case, the turbocharger 18 and/or any turbocharger accessory device(s) may be adjusted to affect any one or more of the following parameters: turbocharger boost pressure, air mass flow, and/or EGR flow. The exhaust subsystem 16 may also include any suitable emissions device(s) 40 such as a catalytic converter like a close-coupled diesel oxidation catalyst (DOC) device, a nitrogen oxide (NOx) adsorber unit, a particulate filter, or the like. The exhaust subsystem 16 may also include an exhaust throttle valve 42 disposed upstream of an exhaust outlet 44.

The EGR subsystem 20 may be a hybrid or multiple path EGR subsystem to recirculate portions of the exhaust gases from the exhaust subsystem 16 to the induction subsystem 14 for combustion in the engine 12. Accordingly, the EGR subsystem 20 may include two or more EGR paths, such as a first or high pressure (HP) EGR path 46 and a second or low pressure (LP) EGR path 48. Also, if more than one turbocharger is used, then one or more additional paths such as one or more medium pressure (MP) paths (not shown) may be used between turbocharger stages. The HP EGR path 46 may be disposed on one side of the turbocharger 18 between the engine 12 and the turbocharger 18, such that the path 46 is connected to the exhaust subsystem 16 upstream of the turbocharger turbine 38 but connected to the induction subsystem 14 downstream of the turbocharger compressor 28. Also, the LP EGR path 48 may be disposed on the other side of the turbocharger 18 from the engine 12, such that the path 48 is connected to the exhaust subsystem 16 downstream of the turbocharger turbine 38 but connected to the induction subsystem 14 upstream of the turbocharger compressor 28.

Any other suitable connection between the exhaust and induction sub-systems 14, 16 is also contemplated including other forms of HP EGR such as the usage of internal engine variable valve timing, lift, phasing, duration, or the like to induce internal HP EGR. According to internal HP EGR, operation of engine exhaust and intake valves may be timed so as to communicate some exhaust gases generated during one combustion event back through intake valves so that exhaust gases are combusted in a subsequent combustion event.

The HP EGR path 46 may include, in addition to suitable conduit and connectors, an HP EGR valve 50 to control recirculation of exhaust gases from the exhaust subsystem 16 to the induction subsystem 14. The HP EGR valve 50 may be a stand-alone device having its own actuator or may be integrated with the intake throttle valve 32 into a combined device having a common actuator. The HP EGR path 46 may also include an HP EGR cooler 52 upstream, or optionally downstream, of the HP EGR valve 50 to cool the HP EGR gases. The HP EGR path 46 may be connected upstream of the turbocharger turbine 38 and downstream of the throttle valve 32 to mix HP EGR gases with throttled air and other induction gases (the air may have LP EGR).

The LP EGR path 48 may include, in addition to suitable conduit and connectors, an LP EGR valve 54 to control recirculation of exhaust gases from the exhaust subsystem 16 to the induction subsystem 14. The LP EGR valve 54 may be a stand-alone device having its own actuator or may be integrated with the exhaust throttle valve 42 into a combined device having a common actuator. The LP EGR path 48 may also include an LP EGR cooler 56 downstream, or optionally upstream, of the LP EGR valve 54 to cool the LP EGR gases. The LP EGR path 48 may be connected downstream of the turbocharger turbine 38 and upstream of the turbocharger compressor 28 to mix LP EGR gases with filtered inlet air.

In one exemplary implementation, the intake throttle valve 27 may be controlled to lower pressure in the induction subsystem 14 and, thus, drive additional LP EGR. This can be done in addition to or instead of controlling one or the other of the HP or LP EGR valves 50, 54.

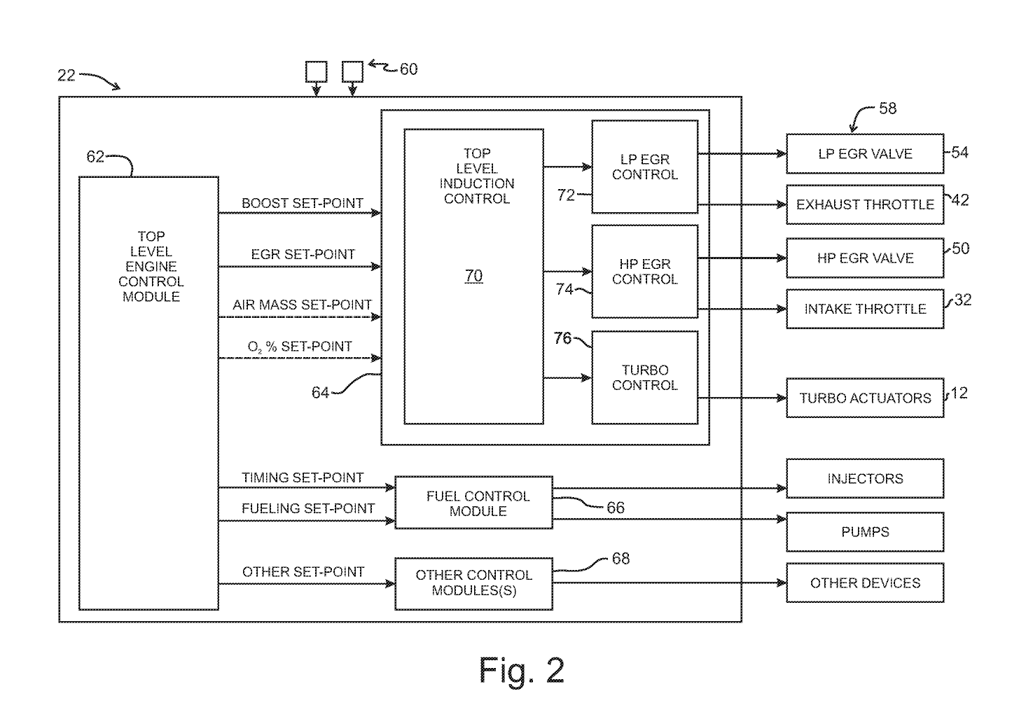

Referring now to FIG. 2, the control subsystem 22 may include any suitable hardware, software, and/or firmware to carry out at least some portions of the methods disclosed herein. For example, the control subsystem 22 may include some or all of the engine system actuators 58 discussed above, as well as various engine sensors 60.

The engine system sensors 60 are not individually shown in the drawings but may include any suitable devices to monitor engine system parameters. For example, an engine speed sensor may measure the rotational speed of an engine crankshaft (not shown), pressure sensors in communication with the engine combustion chambers may measure engine cylinder pressure, intake and exhaust manifold pressure sensors may measure pressure of gases flowing into and away from the engine cylinders, an inlet air mass flow sensor may measure incoming airflow in the induction subsystem 14, and any other mass flow sensor anywhere else in the induction subsystem 14 may measure flow of induction gases to the engine 12. In another example, the engine system 10 may include a temperature sensor to measure the temperature of induction gases flowing to the engine cylinders, and a temperature sensor downstream of the air filter and upstream of the turbocharger compressor 28. In a further example, the engine system 10 may include a speed sensor suitably coupled to the turbocharger compressor 28 to measure the rotational speed thereof. A throttle position sensor, such as an integrated angular position sensor, may measure the position of the throttle valve 32. A position sensor may be disposed in proximity to the turbocharger 18 to measure the position of the variable geometry turbine 38. A tailpipe temperature sensor may be placed just upstream of a tailpipe outlet to measure the temperature of the exhaust gases exiting the exhaust subsystem 16. Also, temperature sensors may be placed upstream and downstream of the emissions device(s) 40 to measure the temperature of exhaust gases at the inlet(s) and outlet(s) thereof. Similarly, one or more pressure sensors may be placed across the emissions device(s) 40 to measure the pressure drop thereacross. An oxygen (O₂) sensor may be placed in the exhaust and/or induction subsystems 14, 16, to measure oxygen in the exhaust gases and/or induction gases. Finally, position sensors may measure the positions of the HP and LP EGR valves 50, 54 and the exhaust throttle valve 42.

In addition to the sensors 60 discussed herein, any other suitable sensors and their associated parameters may be encompassed by the presently disclosed system and methods. For example, the sensors 60 may also include accelerator sensors, vehicle speed sensors, powertrain speed sensors, filter sensors, other flow sensors, vibration sensors, knock sensors, intake and exhaust pressure sensors, NOx sensors, and/or the like. In other words, any sensors may be used to sense any suitable physical parameters including electrical, mechanical, and chemical parameters. As used herein, the term sensor may include any suitable hardware and/or software used to sense any engine system parameter and/or various combinations of such parameters.

The control subsystem 22 may further include one or more controllers (not shown) in communication with the actuators 58 and sensors 60 for receiving and processing sensor input and transmitting actuator output signals. The controller(s) may include one or more suitable processors and memory devices (not shown). The memory may be configured to provide storage of data and instructions that provides at least some of the functionality of the engine system 10 and that may be executed by the processor(s). At least portions of the method may be enabled by one or more computer programs and various engine system data or instructions stored in memory as look-up tables, formulas, algorithms, maps, models, or the like. In any case, the control subsystem 22 may control engine system parameters by receiving input signals from the sensors 60, executing instructions or algorithms in light of sensor input signals, and transmitting suitable output signals to the various actuators 58.

The control subsystem 22 may include one or more modules in the controller(s). For example, a top level engine control module 62 may receive and process any suitable engine system input signals and communicates output signals to an induction control module 64, a fuel control module 66, and any other suitable control modules 68. As will be discussed in greater detail below, the top level engine control module 62 may receive and process input signals from one or more of the engine system parameter sensors 60 to estimate total EGR fraction in any suitable manner The modules 62, 64, 66, 68, may be separate as shown, or may be integrated or combined into one or more modules, which may include any suitable hardware, software, and/or firmware.

Various methods of estimating EGR fraction are known to those skilled in the art. As used herein, the phrase “total EGR fraction” may include one or more of its constituent parameters, and may be represented by the following equation:

$${r}_{EGR} = ( 1 - \frac{MAF}{{M}_{ENG}} ) * 100 = ( \frac{{M}_{EGR}}{{M}_{ENG}} ) * 100 ,$$

where

MAF is fresh air mass flow into an induction subsystem, and may be expressed in kg/s or the like,

M_{EGR} is EGR mass flow into the induction subsystem, and may be expressed in kg/s or the like,

M_{ENG} is induction gas mass flow to an engine, and may be expressed in kg/s or the like, and

r_{EGR} includes that portion of induction gases entering an engine attributable to recirculated exhaust gases.

From the above equation, the total EGR fraction may be calculated using the fresh air mass flow sensor and induction gas mass flow from a sensor or from an estimate thereof, or using an estimate of total EGR fraction itself and the calculated or sensed induction gas mass flow. In either case, the top level engine control module 62 may include suitable data inputs to estimate the total EGR fraction directly from one or more mass flow sensor measurements or estimations as input to one or more engine system models.

As used herein, the term “model” may include any construct that represents something using variables, such as a look up table, map, formula, algorithm and/or the like. Models may be application specific and particular to the exact design and performance specifications of any given engine system. In one example, the engine system models in turn may be based on engine speed and intake manifold pressure and temperature. The engine system models may be updated each time engine parameters change, and may be multi-dimensional look up tables using inputs including engine speed and engine intake gas density, which may be determined with the intake pressure, temperature, and universal gas constant.

The total EGR fraction may be correlated, directly or indirectly via its constituents, to one or more engine system parameters, such as estimated or sensed air mass flow, O₂, or engine system temperature(s). Such parameters may be analyzed in any suitable fashion for correlation with the total EGR fraction. For example, the total EGR fraction may be formulaically related to the other engine system parameters. In another example, from engine calibration or modeling, the total EGR fraction may be empirically and statistically related to the other engine system parameters. In any case, where the total EGR fraction is found to reliably correlate to any other engine system parameter(s), that correlation may be modeled formulaically, empirically, acoustically, and/or the like. For example, empirical models may be developed from suitable testing and may include lookup tables, maps, formulas, algorithm, or the like that may be processed in the total EGR fraction values with other engine system parameter values.

Accordingly, an engine system parameter may be used as a proxy for direct sensor measurements of total EGR fraction and/or individual HP and/or LP EGR flow. Accordingly, total EGR, HP EGR, and LP EGR flow sensors may be eliminated, thereby saving on engine system cost and weight. Elimination of such sensors also leads to elimination of other sensor-related hardware, software, and costs, such as wiring, connector pins, computer processing power and memory, and so on.

Also, the top level engine control module 62 may calculate a turbocharger boost pressure setpoint and a target total EGR setpoint, and transmit these setpoints to the induction control module 64. Similarly, the top level engine control module 62 may calculate suitable timing and fueling setpoints and transmit them to the fuel control module 66, and may calculate other setpoints and transmit them to the other control modules 68. The fuel and other control modules 66, 68 may receive and process such inputs, and may generate suitable command signals to any suitable engine system devices such as fuel injectors, fuel pumps, or other devices.

Alternatively, the top level engine control module 62 may calculate and transmit the boost pressure setpoint and an O₂ percentage setpoint or total intake air mass flow setpoint (as shown in dashed lines), instead of the target total EGR setpoint. In this alternative case, the total EGR setpoint may be subsequently determined from the O₂ percentage or air mass flow setpoints in much the same way the actual total EGR fraction is estimated from the actual mass flow sensor readings. In a second alternative, O₂ percentage and/or air mass flow may replace total EGR fraction throughout the control method. This changes the types of data used and the manner in which HP and LP EGR flow targets are set, but the basic structure of the controller and flow of the control method is the same.

The induction control module 64 may receive any suitable engine system parameter values, in addition to the setpoints received from the top level engine control module 62. For example, the induction control module 64 may receive induction and/or exhaust subsystem parameter values like turbocharger boost pressure, and mass flow. The induction control module 64 may include a top level induction control submodule 70 that may process the received parameter values, and transmit any suitable outputs such as LP and HP EGR setpoints and turbocharger setpoints to respective LP EGR, HP EGR, and turbocharger control submodules 72, 74, 76. The LP EGR, HP EGR, and turbocharger control submodules 72, 74, 76 may process such induction control submodule outputs and may generate suitable command signals to various engine system devices or EGR actuators such as the LP EGR valve 54 and exhaust throttle valve 42, HP EGR valve 50 and intake throttle valve 32, and one or more turbocharger actuators 19. The various modules and/or submodules may be separate as shown, or may be integrated into one or more combined modules and/or submodules.

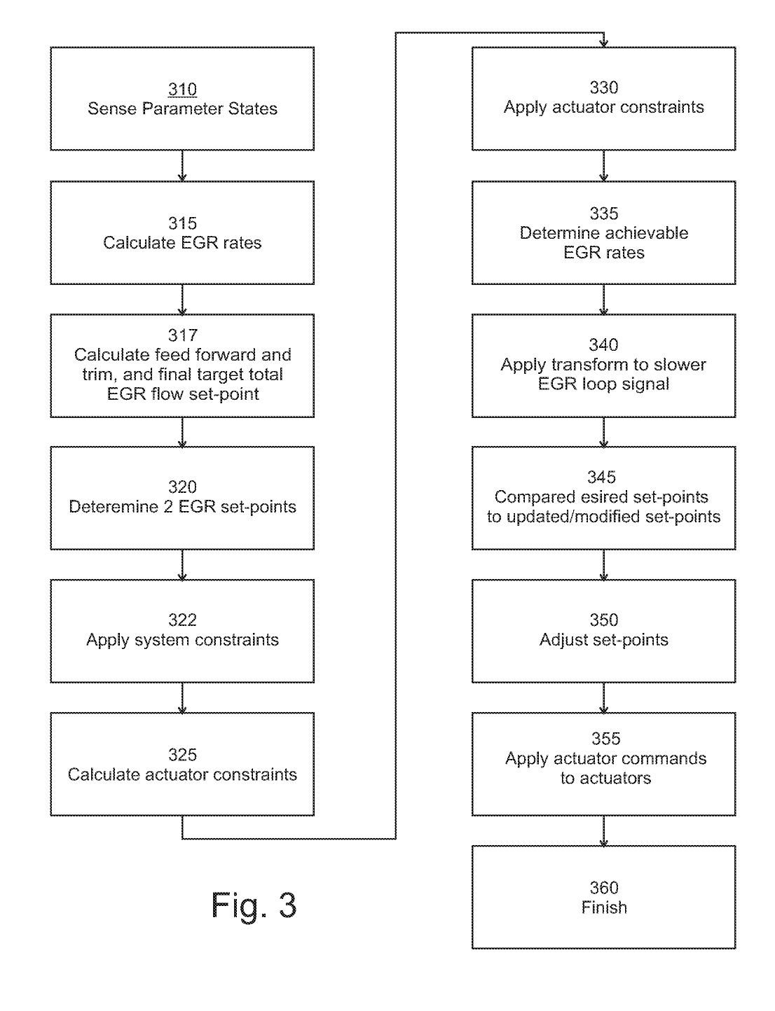

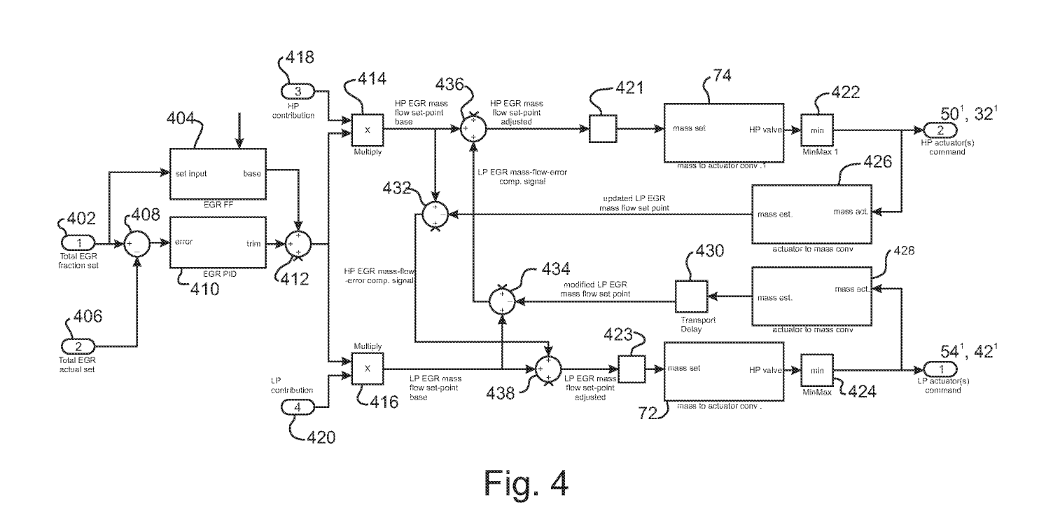

Exemplary embodiments of methods of EGR control may be at least partially carried out as one or more computer programs within the operating environment of the system 10 described above. Those skilled in the art will also recognize that methods according to any number of embodiments may be carried out using other engine systems within other operating environments. Referring now to FIG. 3, an exemplary method 300 is illustrated in flow chart form. As the description of the method 300 progresses, supplemental reference will be made to the system 10 of FIGS. 1 and 2, and to a control flow diagram shown in FIG. 4.

Conventional hybrid EGR systems do not properly account for EGR flow limitations and different dynamic response characteristics of the multiple EGR paths. For example, certain HP/LP ratios or HP and LP contributions may result in damage to an engine system, and other HP/LP ratios or HP and LP contributions may not be achievable given imposed or physical limitations of system devices. In another example, during transients LP EGR response is slower than HP EGR response because of the longer path and a relatively large charge air cooler. Accordingly, the following methods may provide improved EGR control taking into account such limitations for smoother, more fuel efficient operation.

As will be discussed below in greater detail, the methods improve EGR control by determining when flow through one of the EGR paths is insufficient or excessive due to transport delays or actual or imposed flow limitations therethrough, and then redistributing EGR flow amongst the EGR flow paths accordingly. For example, if one of the EGR flow paths is susceptible to transport delays during engine transients and/or is limited by an upper flow limit, then an increased amount of flow can be provided through another EGR path to maintain the total EGR fraction to a desired or target level.

The method 300 may be initiated in any suitable manner For example, the method 300 may be initiated at startup of the engine 12 of the engine system 10 of FIG. 1, and then run at some regular interval, for example every 20 milliseconds.

At step 310, a total EGR fraction may be determined in any suitable manner For example, one or more proxy parameters may be sensed that is/are indicative of the total EGR fraction at any given time. More specifically, the proxy parameter(s) may include air mass flow, O₂%, and/or engine system temperatures, and may be measured by respective sensors 60 of the engine system 10. In another example, flow sensors may be placed in communication with one or more EGR paths and compared to mass flow through an engine to directly determine the total EGR fraction.

In any event, the total EGR fraction may be a directly sensed or estimated actual total EGR value 406. The actual total EGR fraction 406 may be determined using the proxy parameter(s) described previously as well as other standard engine system parameters such as engine load, engine speed, turbocharger boost pressure, and/or engine system temperatures. For example, the proxy parameter may be air mass flow, which may be obtained from any suitable air mass flow estimate or reading such as from the intake air mass flow sensor. In another example, the proxy parameter may be oxygen percentage, such as from an O₂ sensor like the O₂ sensor disposed in the induction subsystem 14. For instance, the O₂ sensor may be a universal exhaust gas oxygen sensor (UEGO), which may be located in the intake manifold 34. In a further example, the proxy parameter may be induction subsystem and exhaust subsystem temperature taken from temperature sensors. For instance, inlet air temperature may be used such as from the air inlet temperature sensor, exhaust temperature such as from the exhaust temperature sensor, and manifold temperature such as from the intake manifold temperature sensor. In all of the above-approaches, the actual total EGR fraction may be estimated from one or more proxy parameter types.

As used herein, the term “target” includes a single value, multiple values, and/or any range of values. Also, as used herein, the term “criteria” includes the singular and the plural. Examples of criteria used to determine appropriate EGR fraction(s) include calibrated tables based on speed and load, model based approaches which determine cylinder temperatures targets and convert to EGR fraction and operating conditions such as transient operation or steady state operation. Absolute emissions criteria may be dictated by environmental entities such as the U.S. Environmental Protection Agency (EPA).

At step 315, a target total EGR setpoint may be determined on any suitable basis, such as for compliance with exhaust emissions criteria. The target total EGR setpoint may be output in any suitable format such as a ratio of exhaust gas to fresh air, a fraction, or an absolute mass flow value in any suitable units such as kg/s or the like for ease in allocating the setpoint between constituent EGR contributions, such as HP and LP EGR contributions. For example, the top level engine control module 62 may use any suitable engine system model(s) to cross-reference current engine operating parameters with desirable or target total EGR fraction values to comply with predetermined emissions standards. Using such a cross-reference, the control module 62 may determine and output an initial target total EGR setpoint 402 (FIG. 4), which may be a fraction, such as 40%. Also, the control module 62 may determine and output the directly sensed or estimated actual total EGR value 406, which also may be a fraction, such as 41%. The control module 62 may compare the initial target and actual total EGR fractions at an arithmetic node 408 that calculates the difference or error therebetween for input to a closed loop control block 410.

At step 317, total EGR feedforward and trim values may be determined, as well as a final target total EGR flow setpoint. For example, the total EGR setpoint 402 may be converted by a feedforward control block 404 to another format such as an absolute target flow setpoint in any suitable flow rate units such as kg/s. For example, engine mass flow may be determined and then multiplied by the initial target total EGR setpoint fraction to obtain an EGR mass flow set point. The feedforward control block 404 may receive any suitable input parameters such as engine speed, load, boost pressure, intake air temperature, or the like. An exemplary EGR mass flow set point value may be 0.01 kg/s. The control block 410 may be any suitable closed-loop control means, such as a PID controller block or the like, for controlling total EGR and may process the error input to generate a feedback control signal or trim command for adjustment of the feedforward total EGR flow setpoint at a downstream arithmetic node 412. As a result, the final target total EGR flow setpoint is output from the arithmetic node 412 and fed to downstream to interrelated first and second EGR control functions.

At step 320, first and second EGR setpoints may be established. For example, a target total EGR flow setpoint may be distributed amongst multiple EGR paths, such as first or HP and second or LP EGR paths. More particularly, the target total EGR flow setpoint determined in step 315 and output by the arithmetic node 412 of FIG. 4 may be distributed among the exemplary HP and LP EGR paths of FIG. 4 to produce base target HP and LP EGR flow setpoints. In turn, the base target HP and LP EGR flow setpoints contribute to the target total EGR setpoint. More specifically, the target total EGR flow setpoint may be multiplied at arithmetic nodes 414, 416 by target HP and LP contributions 418, 420, respectively.

The target HP and LP EGR contributions 418, 420 may be determined on any suitable basis, for example, initially for compliance with exhaust emissions criteria and then to optimize other criteria such as engine system safety, vehicle safety, exhaust filter regeneration temperatures, and/or the like. The induction control module 64 may receive and process various engine system inputs to identify optimal HP and LP contributions. The induction control module 64 may receive and process various engine system inputs, such as engine speed, engine load, and/or total EGR setpoint, to identify and/or adjust an optimal HP/LP EGR ratio and generate corresponding HP and LP EGR contributions according to that identified and/or adjusted ratio.

The induction control module 64 may prioritize fuel economy criteria for identifying the optimal HP and LP contributions, and then generate the setpoints by executing the arithmetic function 414. According to fuel economy optimization, the induction control module 64 may include any suitable net turbocharger efficiency model that encompasses various parameters such as pumping losses, and turbine and compressor efficiencies. The efficiency model may include a principles based mathematical representation of the engine induction subsystem 14, a set of engine system calibration tables, or the like. Example criteria used to determine desired HP and LP EGR contributions to meet fuel economy criteria may include setting a ratio that allows the target total EGR fraction to be achieved without the need for closing the intake or exhaust throttles, which closing tends to negatively impact fuel economy, or the ratio may be adjusted to achieve an optimal induction temperature for maximum fuel economy.

The induction control module 64 may also override the fuel economy criteria to instead optimize other engine system criteria for any suitable purpose. For example, the fuel economy criteria may be overridden to provide an HP and LP contributions that provide improved engine system performance, such as increased torque output in response to driver demand for vehicle acceleration. In this case, the induction control module 64 may favor a higher LP EGR contribution, which allows better turbocharger speed-up to reduce turbo lag. In another example, the override may provide different fractions or contributions to achieve an HP/LP EGR ratio to protect the engine system 10 such as to avoid a turbocharger overspeed condition or excess compressor tip temperatures, or to reduce turbocharger condensate formation, high exhaust temperatures, or to heat up a catalyst, or prevent excessive exhaust temperatures, or to hasten warm up of a catalyst, and/or the like. In a further example, the override may provide yet different contributions to achieve another HP/LP EGR ratio to maintain the engine system 10 such as by affecting induction or exhaust subsystem temperatures. For instance, exhaust subsystem temperatures may be increased to regenerate a diesel particulate filter, and induction temperatures may be reduced to cool the engine 12. As a further example, induction temperature may be controlled to reduce the potential for water condensate to form in the inlet induction path.

The induction control module 64 may determine the percentage of the total EGR fraction setpoint that will be allocated to LP EGR and to HP EGR. Because, in the present example, LP and HP EGR are the only two sources of EGR, their percentage contributions add up to 100% at least during steady-state system operation. For example, during cold engine operation, the ratio determination block 478 may allocate only about 10% of the total EGR fraction to LP EGR and about 90% of the total EGR fraction to HP EGR, which is normally warmer than LP EGR, so as to more quickly warm up the engine. During other modes of operation, the induction control module 64 may allocate the total EGR fraction according to any other HP/LP EGR ratios such as 50/50, 20/80, etc.

At step 322, system constraints may be applied to base or adjusted HP and LP EGR setpoints to produce constrained HP and LP EGR setpoints. More particularly, base or adjusted HP and LP EGR setpoints may be constrained if they go beyond or exceed mass flow limits and/or fall short of or subceed respective mass flow, which may be represented by limit function blocks 421, 423 in FIG. 4. For example, the induction control module 64 may compare an LP EGR setpoint to upper and/or lower LP EGR mass flow limits to prevent insufficient and/or excessive LP EGR mass flow levels.

At step 325, EGR actuator commands corresponding to EGR setpoints may be determined. For example, the LP and HP EGR control blocks 72, 74 may receive respective LP and HP EGR setpoints in addition to the turbocharger boost pressure and the engine load and speed inputs. The LP and HP EGR control blocks 72, 74 may receive such inputs for open-loop or feedforward control of their respective LP and HP EGR actuators. For instance, the LP and HP EGR control blocks 72, 74 may output LP EGR valve and/or exhaust throttle commands 54′, 42′, and HP EGR valve and/or intake throttle commands 50′, 32′. The EGR actuator commands may include valve opening or closing percentages, or any other suitable commands/signals.

The LP and HP EGR control blocks 72, 74 may correlate HP and LP EGR flow to suitable HP and LP EGR valve and/or throttle positions using one or more suitable models. The LP and HP EGR control blocks 72, 74 may include various open-loop control models. For instance, the LP and HP EGR control blocks 72, 74 may include any suitable model(s) to correlate the LP and HP EGR setpoints to the LP and HP EGR actuator positions to help achieve target HP/LP EGR ratios and/or LP and HP contribution or flow setpoints.

At step 330, system constraints may be applied to HP and LP EGR actuator commands to produce constrained HP and LP EGR actuator commands. More particularly, EGR actuator commands may be adjusted if they go beyond or exceed actuator limits and/or fall short of or subceed respective actuator limits, which may be represented by limit function blocks 422, 424 in FIG. 4. For example, the induction control module 64 may compare an LP EGR actuator command to upper and/or lower LP EGR actuator limits to prevent insufficient and/or excessive LP EGR levels. An example includes an imposed closing limit of an EGR throttle valve due to prevent undesirable back pressure in the exhaust system. Another example includes a physical maximum limit wherein an EGR actuator is already fully opened or closed and cannot possibly be opened or closed any further. An exemplary imposed upper limit for LP EGR may be 90% and an exemplary imposed lower limit for LP EGR may be 10%. Accordingly, if an LP EGR value included a 95% LP EGR, then the induction control module 64 would override the value and instead output a 90% LP EGR value. Similarly, if an LP EGR value included a 5% LP EGR, then the induction control module 64 would override that value and output a 10% LP EGR value. According to another embodiment, the induction control module 64 may similarly limit HP EGR for any suitable reason. According to a further embodiment, the limits may be fixed or static, or may be dynamic such that the limits are higher or lower depending on instantaneous operating conditions of the engine system, or may be automatically calibrated during operation such as by moving a corresponding actuator to find its hard stops. In any case, the limits may be implemented using any suitable models such as look up tables or the like and any suitable engine system input variables.

At step 335, updated EGR flow setpoints corresponding to the constrained HP and LP EGR actuator commands may be determined. For example, achievable or updated HP and LP EGR flow setpoints corresponding to the HP and LP EGR actuator commands may be determined as represented by conversion blocks 426, 428, respectively. This step basically may be the inverse operation of steps 72, 74, wherein the output commands from blocks 422, 424 may be converted back to corresponding mass flow values.

At step 340, a transfer function may be applied to the updated LP EGR flow setpoint to produce a modified LP EGR setpoint. More particularly, a system transfer function, represented by block 430, may be applied to the updated LP EGR flow setpoint from conversion block 428. During steady state system operation, a lowering of a flow setpoint of one of the HP and LP EGR by a given amount and a raising of a flow setpoint of the other by the same amount will result in no change to the total EGR. But there is a time lag between HP and LP EGR wherein changes in HP EGR reach the engine before changes in LP EGR because of, for example, the relatively greater distance that LP exhaust gases travel compared to HP exhaust gases and the relatively larger charge air cooler. In other words, because the LP EGR loop is longer and greater in volume than the HP EGR loop, changes in LP EGR take longer to affect the actual in-cylinder EGR rate than changes in HP EGR.

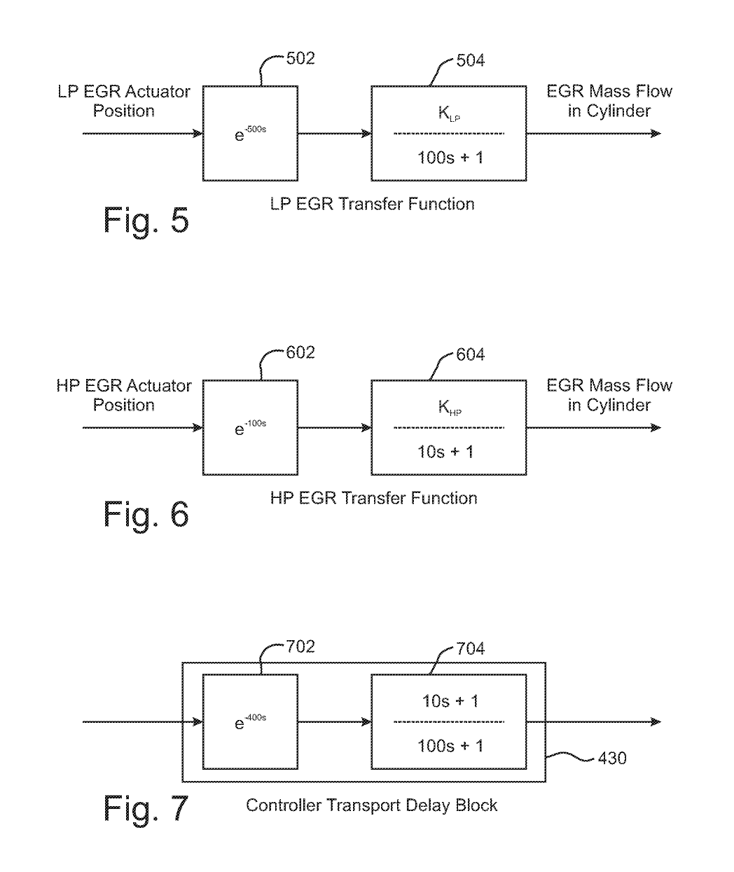

These transport delays are exemplified in FIGS. 5 and 6, wherein exemplary LP and HP transport functions include dead time function blocks 502, 602 and lag time function blocks 504, 604 with exemplary time values. The dynamic compensation transfer function 430 can be derived from the LP and HP transport functions, as represented in FIG. 7 by derived dead time and lag time function blocks 702, 704. Without this function 430, if the HP and LP EGR flow setpoints are simultaneously changed by the same amount, then the total EGR will be incorrect for a short period of time. That time represents the transport delay between when the flow change in HP EGR reaches the engine and when the flow change in LP EGR reaches the engine. But with this dynamic compensation transfer function 430, under the same conditions total EGR will be correct.

In a specific example, if a total EGR fraction of 20% is split 50/50 between HP and LP EGR, then both HP and LP EGR contributions would be 10%. If the HP/LP EGR ratio was changed to 40/60, then the HP EGR contribution to the total EGR fraction would decrease to 8% and the LP EGR contribution would, eventually, increase to 12% to yield the 20% total EGR fraction over the long term. But over a shorter term, while the HP EGR contribution would decrease to 8% relatively quickly, the LP EGR contribution would increase relatively slowly and the engine may see less than the 12% LP EGR contribution for some time. Hence, the engine would temporarily experience less than the 20% total EGR, somewhere between 18%-20% total EGR. In other words, the engine would experience a drop in total EGR for a short period of time with a concomitant effect on emissions performance.

The transfer functions of FIGS. 5-7 are just examples of first order approximations of the system that are provided for illustrative purposes. More extensive mathematical models such as second or higher order models may be used and “zeros” may be added, such as terms like (5s+1) in the numerator. Also, in actual implementations, dead times may be approximated by Pade approximations, which are practical methods of implementing a pure delay time. In any event, any suitable models that approximate the behavior of the EGR paths may be used and the inverse of the dynamics of the faster of the multiple EGR paths are applied to a model of the second loop to create the dynamic compensation block of FIG. 7.

Moreover, the EGR actuator positions exemplified in FIGS. 5 and 6 may be scaled to 0% to 100%. In other words, the actual closed to open limit positions of the actuator may be, for example, 5% open to 95% open. But, this less than 100% actual range may be scaled proportionally or otherwise to correspond to a 0% to 100% range for purposes of applying the transfer functions.

At step 345, target EGR flow setpoints may be compared to updated and/or modified EGR flow setpoints. For example, as represented by arithmetic nodes 432, 434 in FIG. 4, the target HP and LP EGR flow setpoints from step 320 may be compared to the updated HP and LP EGR flow setpoints and/or modified LP EGR flow setpoint from steps 335 and/or 340. Output from the nodes 432, 434 may include respective mass flow error compensation signals.

At step 350, target EGR flow setpoints are adjusted in response to a comparison to updated and/or modified EGR flow setpoints to produce adjusted target EGR flow setpoints. For example, if the compared EGR setpoints from step 345 are equivalent, then the difference is zero and the EGR setpoints are likewise equal. Otherwise, any non-zero difference in the LP EGR flow setpoints is applied to an HP EGR arithmetic node 436 to reallocate the shortfall or excess in LP EGR to HP EGR by way of an increase or decrease in the target HP EGR flow setpoint. Likewise, any non-zero difference in HP EGR setpoints is applied to an LP EGR arithmetic node 438 to reallocate the shortfall or excess in HP EGR to LP EGR by way of an increase or decrease in the target LP EGR flow setpoint. Accordingly, EGR transport delay and/or actuator limitations may be smoothly handled by rebalancing or reallocating HP and LP EGR flow setpoints to optimally achieve the target total EGR flow.

At step 355, EGR actuator commands may be applied to one or more EGR actuators. For example, the HP and LP EGR actuator commands from steps 325 and/or 350 may be applied to HP EGR, LP EGR, intake throttle, and/or exhaust throttle valves.

Finally, at step 360, the method 300 may be terminated in any suitable manner

For example, the method 300 may be terminated at shutdown of the engine 12 of the engine system 10 of FIG. 1.

According to another exemplary implementation of the method 300, more than two EGR paths may be controlled according to the method steps. For instance, the method 300 can be used to control three or four EGR paths in an engine system including, for example, internal EGR, HP EGR, MP EGR, and LP EGR, or the like. In a first example of such an implementation, the method could be applied so that one of internal EGR, HP EGR, or MP EGR is the first EGR path, and LP EGR is the second EGR path. In a second example, the method could be cascaded such that initially HP EGR is the first EGR path and LP EGR is the second path and, subsequently, internal EGR is the first EGR path and HP EGR is the second EGR path. Similarly, the method could be cascaded such that initially MP EGR is the first EGR path and LP EGR is the second path and, subsequently, HP EGR is the first EGR path and MP EGR is the second EGR path. In a more specific illustration, the method could be run for a predetermined time, number of cycles, or the like amongst a first two of the three or four EGR paths, and then run another predetermined time, number of cycles, or the like amongst a second two of the three or four EGR paths.

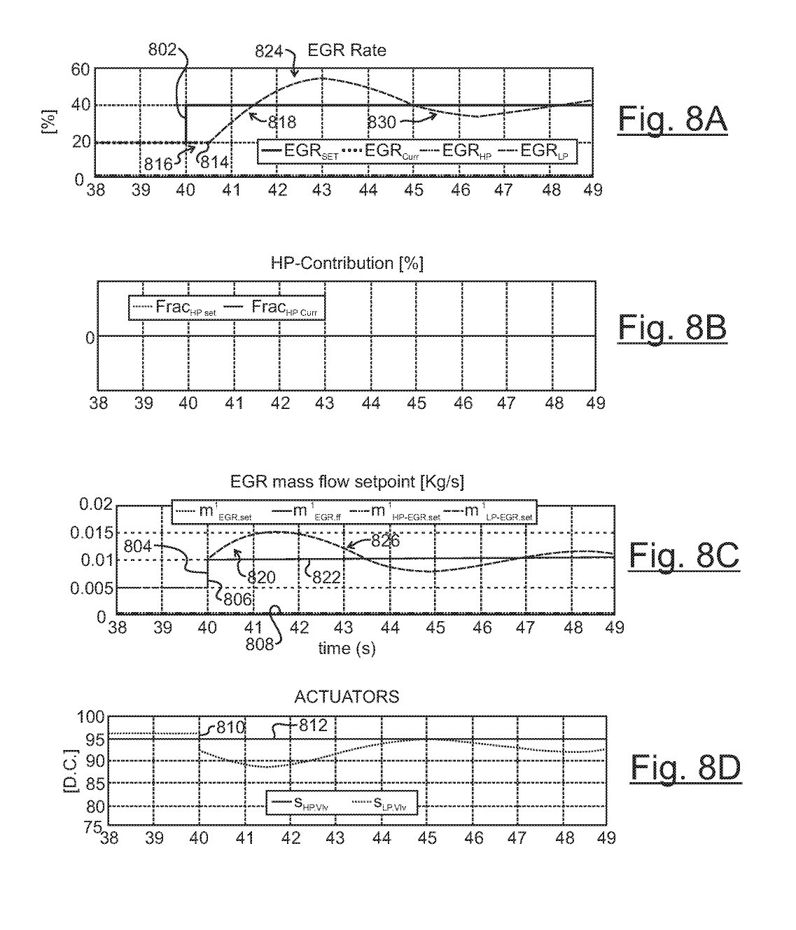

Referring now to FIGS. 8A through 11D, exemplary simulations of the exemplary methods are illustrated. First, prior art FIGS. 8A-8D demonstrate what happens under a conventional hybrid EGR control scheme when target total EGR flow is suddenly increased while target HP EGR flow is maintained at a constant low (or zero level in this example), such as during a load change where cooler intake gas is desired. In this example, a target total EGR setpoint is suddenly commanded upward from an exemplary fractional value of 20% to an exemplary fractional value of 40% as shown by trace 802 in FIG. 8A, and from a corresponding exemplary flow value of 0.005 kg/s to an exemplary flow value of 0.010 kg/s as shown by trace 804 in FIG. 8C. Simultaneously, an LP EGR flow setpoint is commanded upward from an exemplary flow value of 0.005 kg/s to an exemplary flow value of 0.010 kg/s as shown by trace 806, while an HP EGR flow setpoint is maintained at 0 kg/s as shown by trace 808. Also simultaneously, an LP EGR actuator is commanded toward a more open position while an HP EGR actuator is maintained in position, as shown by traces 810 and 812 in FIG. 8D.

Despite the instantaneous increase in the LP EGR flow setpoint shown in FIG. 8C, and the concomitant LP EGR actuator opening shown in FIG. 8D, the actual LP EGR contribution and actual total EGR fraction, as both shown by trace 814 of FIG. 8A, do not likewise instantaneously increase as illustrated by a dead time portion 816 and a sloped portion 818 of the trace 814. FIG. 8B illustrates that an HP EGR contribution setpoint and the actual HP EGR contribution stay at 0%. To compensate for such transport delays, the LP EGR flow setpoint is increased, as shown by an upswing portion 820 of the trace 806, above a total EGR feedforward setpoint (trace 822) as shown in FIG. 8C. Then, the actual LP EGR contribution overshoots as shown by an overshoot portion 824 of the trace 814 in FIG. 8A. Because of a large delay in response, the controller may exhibit large overshoot or undershoot. At least some of the overshoot or undershoot illustrated in the figures may be attributed to simulation tuning. In response to the overshoot, the LP EGR flow setpoint is decreased, as shown by a downswing portion 826 of the trace 806, below the target total EGR setpoint as shown in FIG. 8C. Then, the actual LP EGR contribution undershoots as shown by an undershoot portion 830 of the trace 814 in FIG. 8A. This cycle repeats until, eventually, the LP EGR flow setpoint and the actual LP EGR contribution converge on the target total EGR flow setpoint and actual total EGR fraction. But, depending on the circumstances, this convergence may take several seconds.

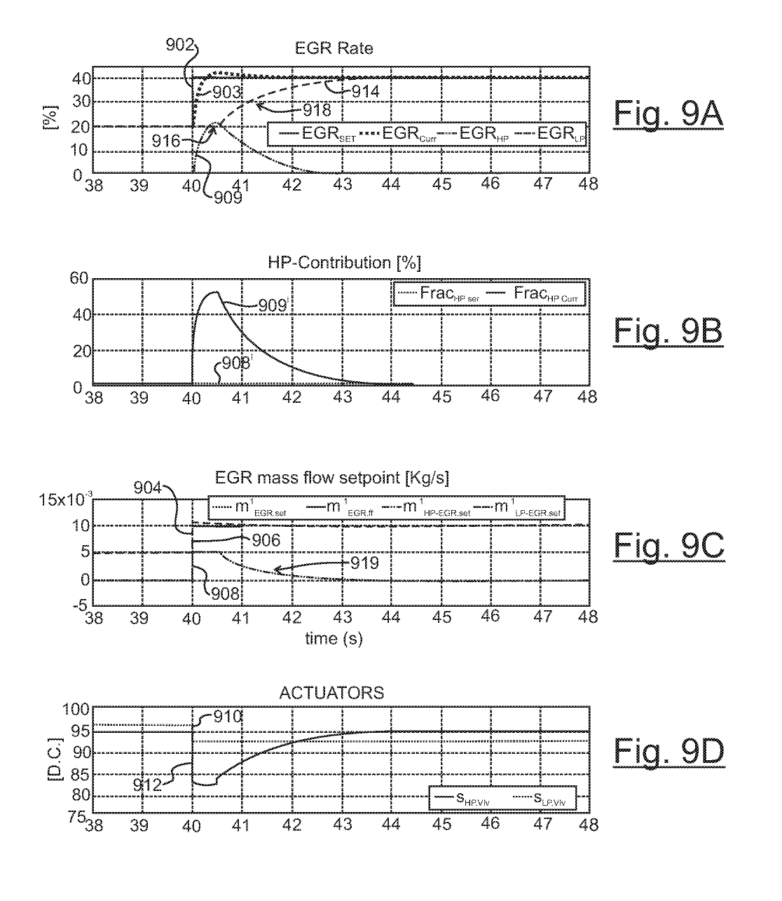

FIGS. 9A-9D demonstrate what happens using the presently disclosed exemplary methods when target total EGR flow is suddenly increased while target HP EGR flow is maintained at a constant low (or zero level in this example), such as during a load change where cooler intake gas is desired. In this example, the target total EGR setpoint is commanded upward from an exemplary fractional value of 20% to an exemplary fractional value of 40% as shown by trace 902 in FIG. 9A and from an exemplary flow value of 0.005 kg/s to an exemplary flow value of 0.010 kg/s as shown by trace 904 in FIG. 9C. As a result, an LP EGR flow setpoint suddenly increases from an exemplary flow value of 0.005 kg/s to an exemplary flow value of 0.010 kg/s as shown by trace 906, while, according to the methods, an HP EGR flow setpoint temporarily increases from 0 kg/s to 0.005 kg/s as shown by trace 908. Although an HP EGR contribution setpoint remains constant as shown by trace 908′, an actual HP EGR contribution temporarily spikes as shown by trace 909′ to make up for a temporary shortfall in actual LP EGR contribution. Both LP and HP EGR actuators are commanded toward more open positions, as shown by traces 910 and 912 in FIG. 9D.

In contrast to the prior art, with the instantaneous increase in the LP and HP EGR flow setpoints shown in FIG. 9C, and the concomitant increased actuator openings shown in FIG. 8D, the actual HP EGR contribution and total EGR fractions shown by traces 909 and 903 of FIG. 8A likewise instantaneously increase, even though the increase in actual LP EGR contribution is delayed as illustrated by a dead time portion 916 and a sloped portion 918 of trace 914. But as LP EGR flow increases, the HP EGR flow decreases as shown by portion 919. Such temporary rebalancing of EGR flows from LP to HP EGR compensates for transport delays in the LP EGR path. Accordingly, the total EGR fraction rapidly meets the target total EGR fraction setpoint, such as within about one to three seconds. This represents a two-fold to fifteen-fold increase in total EGR fraction responsiveness over the prior art.

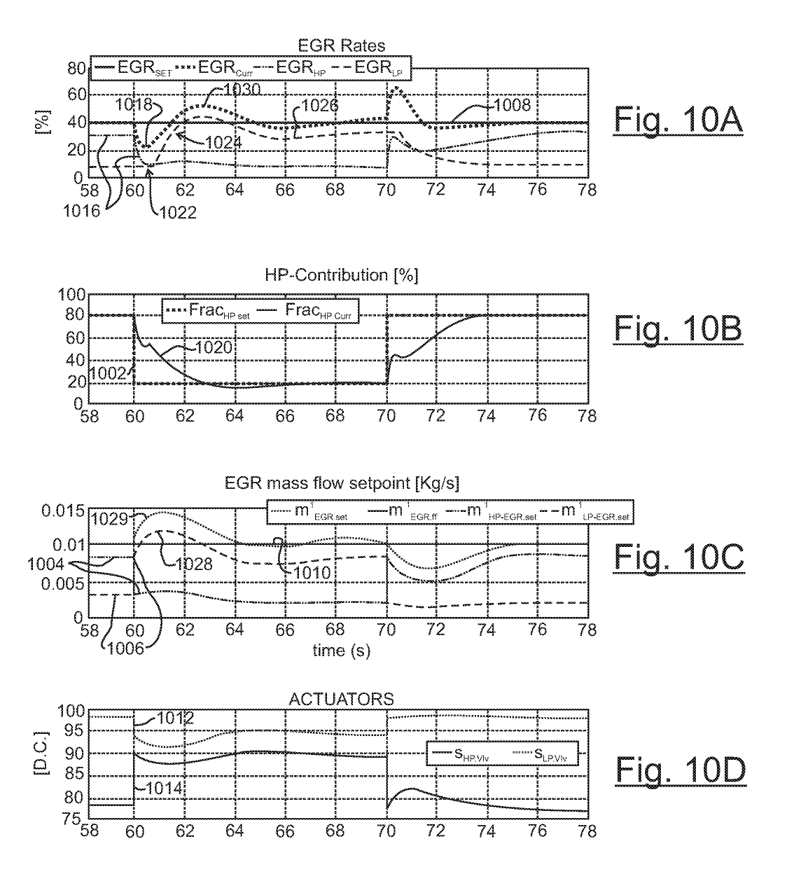

FIGS. 10A-10D demonstrate what happens under a conventional hybrid EGR control scheme when an HP EGR contribution setpoint is suddenly changed and, thereafter, is suddenly changed back, while a target total EGR feedforward setpoint is maintained constant, such as when catalyst lightoff is achieved. In this example, the HP EGR contribution setpoint is commanded downward from an exemplary value of 80% to an exemplary value of 20% as shown by trace 1002 in FIG. 10B. Accordingly, a corresponding HP flow setpoint decreases from an exemplary value of 0.008 kg/s to an exemplary value of 0.002 kg/s as shown by trace 1004 in FIG. 10C, while an LP EGR flow setpoint is commanded upward from an exemplary flow value of 0.002 kg/s to an exemplary flow value of 0.008 kg/s as shown by trace 1006 in FIG. 10C. Simultaneously, a total EGR fraction setpoint is maintained constant as shown by trace 1008 in FIG. 10A, and a total EGR flow feedforward signal is maintained constant as shown by trace 1010 in FIG. 10C. Consequently, an LP EGR actuator is commanded from a near fully closed position toward a more open position while an HP EGR actuator is command toward a more closed position, as shown by traces 1012 and 1014 in FIG. 8D.

As a result, an exemplary HP EGR contribution to total EGR percentage instantaneously starts to decrease from 32% toward 8% as shown by trace 1016 in FIG. 10A, with a near simultaneous decrease in total EGR fraction from 40% to 20% as shown by trace 1018 in FIG. 10A. Likewise, an exemplary HP EGR contribution decreases from 80% to 20% as shown by trace 1020 in FIG. 10B. But despite such instantaneous responses, the actual LP EGR contribution to the total EGR fraction does not likewise instantaneously respond, as illustrated by a dead time portion 1022 and a sloped lag time portion 1024 of a trace 1026.

To compensate for such transport delays, the LP EGR flow setpoint is increased, as shown by an upswing portion 1028 of the trace 1006, above the target total EGR feedforward signal 1010 as shown in FIG. 10C. Likewise, the total EGR mass flow setpoint increases from an exemplary value of 0.010 kg/s as shown by trace 1029 of FIG. 10C. As a result, the actual total EGR fraction overshoots as shown by an overshoot portion 1030 in FIG. 10A. A similar phenomenon occurs when the HP EGR contribution is suddenly returned to its original setpoint, but in reverse order. Accordingly, total EGR varies wildly instead of remaining substantially constant.

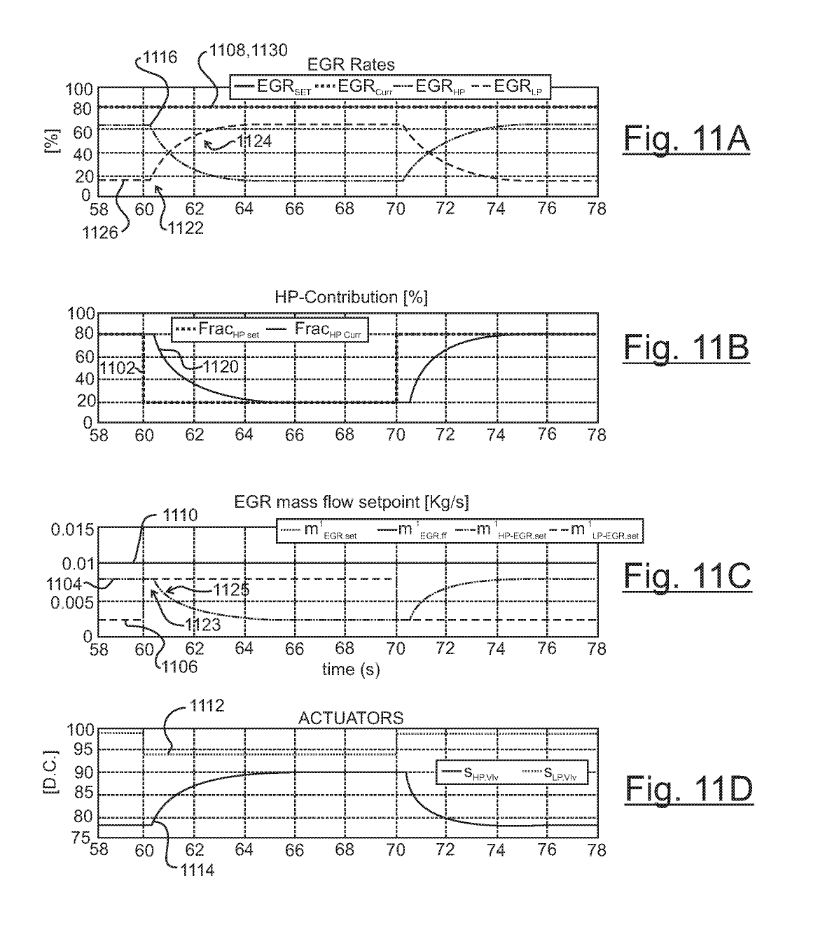

FIGS. 11A-11D demonstrate what happens using the presently disclosed exemplary EGR control methods when an HP EGR contribution setpoint is suddenly command downward and, shortly thereafter, is suddenly commanded upward, while a target total EGR feedforward setpoint is maintained constant, such as when catalyst lightoff is achieved. In this example, the HP EGR contribution setpoint is commanded downward as shown by trace 1102 of FIG. 11B. Simultaneously, the LP EGR flow setpoint is commanded upward as shown by trace 1106 of FIG. 11C, and the LP EGR actuator is moved toward a more open position as shown by trace 1112. But due to the LP EGR transport delay, the LP EGR contribution to the total EGR fraction does not instantaneously increase or achieve the target as indicated by the delay 1122 and lag time slope 1124 in trace 1126 of FIG. 11A.

Therefore, in accordance with the concomitant EGR rebalancing of the FIG. 4 control scheme, the HP EGR flow setpoint as shown by trace 1104 of FIG. 11C is not simultaneously commanded downward until after a delay 1123 from the dead time block 702 of FIG. 7 and then according to a lag time slope 1125 dictated by the lag time block 704 of FIG. 7 of the transfer function 430 in FIG. 7. Accordingly, the HP EGR actuator is moved toward a more closed position after the delay and according to the lag time slope as shown by trace 1114 in FIG. 11D.

As a result, an exemplary HP EGR contribution to total EGR percentage decreases after the dead time and according to the lag time slope from 32% toward 8% as shown by trace 1116 in FIG. 11A and by trace 1120 in FIG. 11B, with a simultaneous increase in LP EGR contribution to total EGR percentage according to the dead time and an inverse of the lag time slope from 8% toward 32% as shown by trace 1126 in FIG. 11A. The simultaneous rebalancing results in substantially constant actual and setpoint values for total EGR fraction as shown by traces 1108 and 1130 of FIG. 11A, and in substantially constant total EGR mass flow setpoint and feedforward values as shown by traces 1110, 1129 of FIG. 11C. A similar result is achieved when the HP EGR contribution is suddenly commanded upward.

The above description of embodiments is merely exemplary in nature and, thus, variations thereof are not to be regarded as a departure from the spirit and scope of the invention.

1. A method of controlling exhaust gas recirculation (EGR) in a turbocharged engine system including a first EGR path and a second EGR path, the method comprising:
a) providing first and second EGR setpoints, which are associated with the first and second EGR paths and contribute to a total EGR setpoint; and
b) applying a transfer function to at least one of the first and second EGR setpoints to account for at least one of dead time or lag time associated with the second EGR path.

2. The method of claim 1 wherein the first and second EGR setpoints are established by multiplying a target total EGR flow setpoint by target first and second EGR contributions.

3. The method of claim 2 wherein the target total EGR flow setpoint is determined on a basis of compliance with exhaust emissions criteria, and the target first and second EGR contributions are determined first on the basis of compliance with exhaust emissions criteria and then to optimize other criteria.

4. The method of claim 1 wherein the transfer function is a dynamic compensation transfer function derived from a first transfer function associated with the first EGR path and a second transfer function associated with the second EGR path.

5. The method of claim 1, further comprising:
c) determining first and second EGR actuator commands corresponding to at least one of the first and second EGR setpoints established in step a) or the adjusted first and second EGR setpoints from step h);
d) applying respective actuator limits to the first and second EGR actuator commands determined in step c) to produce constrained first and second EGR actuator commands;
e) determining updated first and second EGR setpoints corresponding to the constrained first and second EGR actuator commands from step d);
f) wherein the transfer function from step b) is applied to the updated second EGR setpoint from step e) to produce a modified second EGR setpoint;
g) comparing the updated first and modified second EGR setpoints to the first and second EGR setpoints from step a); and
h) adjusting the first and second EGR setpoints from step a) based on the comparison from step g) to generate adjusted first and second EGR setpoints.

6. The method of claim 5 wherein the first and second EGR actuator commands are associated with at least one of exhaust valve opening or closing percentages.

7. A method of controlling exhaust gas recirculation (EGR) in a turbocharged engine system including a first EGR path and a second EGR path, the method comprising:
a) determining first and second EGR actuator commands corresponding to first and second EGR setpoints;
b) applying system constraints to the first and second EGR actuator commands to produce constrained first and second EGR actuator commands;
c) determining updated first and second EGR setpoints corresponding to the constrained first and second EGR actuator commands;
d) comparing the first EGR setpoint to the updated first EGR setpoint; and
e) adjusting the first and second EGR setpoints in response to the comparison of step d) to produce adjusted first and second EGR setpoints.

8. The method of claim 7 wherein the first and second EGR setpoints are initially established by multiplying a target total EGR flow setpoint by target first and second EGR contributions.

9. The method of claim 8 wherein the target total EGR flow setpoint is determined on a basis of compliance with exhaust emissions criteria, and the target first and second EGR contributions are determined first on the basis of compliance with exhaust emissions criteria and then to optimize other criteria.

10. The method of claim 7, further comprising:
g) applying a transfer function to the updated second EGR setpoint from step c) to produce a modified second EGR setpoint;
h) comparing the second EGR setpoint to the modified second EGR setpoint; and
i) adjusting the first and second EGR setpoints from step a) in response to the comparisons of steps d) and h) to generate adjusted first and second EGR setpoints.

11. The method of claim 10 wherein the transfer function is a dynamic compensation transfer function derived from a first transfer function associated with the first EGR path and a second transfer function associated with the second EGR path.

12. The method of claim 7 wherein the first and second EGR actuator commands are associated with at least one of exhaust valve opening or closing percentages.

13. The method of claim 7, wherein the first and second EGR paths are high pressure (HP) and low pressure (LP) EGR paths.

14. The method of claim 13, wherein the HP EGR path is an internal HP EGR path in an engine of the engine system.

15. A method of controlling exhaust gas recirculation (EGR) in a turbocharged engine system including a first EGR path and a second EGR path, the method comprising:
a) establishing base first and second EGR setpoints;
b) applying system constraints to the base first and second EGR setpoints to produce constrained first and second EGR setpoints;
c) determining first and second EGR actuator commands from the constrained first and second EGR setpoints;
d) determining updated first and second EGR setpoints corresponding to the determined first and second EGR actuator commands;
e) comparing the base first EGR setpoint to the updated first EGR setpoint; and
f) adjusting the base second EGR setpoint in response to the comparison of step e) to produce an adjusted second EGR setpoint.

16. The method of claim 15, wherein the system constraints include first and second EGR mass flow constraints.

17.-23. (canceled)

24. A product comprising:
a controller to control exhaust gas recirculation (EGR) and configured to:
provide first and second EGR setpoints, which are associated with first and second EGR paths and contribute to a total EGR setpoint, and
apply a transfer function to at least one of the first and second EGR setpoints to account for at least one of dead time or lag time associated with the second EGR path.

25. The product of claim 24 wherein the first and second EGR setpoints are established by multiplying a target total EGR flow setpoint by target first and second EGR contributions.

26. The product of claim 25 wherein the target total EGR flow setpoint is determined on a basis of compliance with exhaust emissions criteria, and the target first and second EGR contributions are determined first on the basis of compliance with exhaust emissions criteria and then to optimize other criteria.

27. The product of claim 24 wherein the transfer function is a dynamic compensation transfer function derived from a first transfer function associated with the first EGR path and a second transfer function associated with the second EGR path.

28. The product of claim 24, wherein the controller is further configured to:
determine first and second EGR actuator commands corresponding to at least one of the established first and second EGR setpoints or adjusted first and second EGR setpoints;
apply respective actuator limits to the determined first and second EGR actuator commands to produce constrained first and second EGR actuator commands;
determine updated first and second EGR setpoints corresponding to the produced constrained first and second EGR actuator commands;
apply the transfer function to the updated second EGR setpoint to produce a modified second EGR setpoint;
compare the updated first and modified second EGR setpoints to the determined first and second EGR setpoints; and
adjust the provided first and second EGR setpoints based on the comparison, to generate the adjusted first and second EGR setpoints.

29. The product of claim 28 wherein wherein the controller is further configured to associate the determined first and second EGR actuator commands with at least one of exhaust valve opening or closing percentages.

30. A product comprising:
a controller to control exhaust gas recirculation (EGR) and configured to:
determine first and second EGR actuator commands corresponding to first and second EGR setpoints;
apply system constraints to the determined first and second EGR actuator commands to produce constrained first and second EGR actuator commands;
determine updated first and second EGR setpoints corresponding to the constrained first and second EGR actuator commands;
compare the first EGR setpoint to the updated first EGR setpoint; and
adjust the first and second EGR setpoints in response to the comparison to produce adjusted first and second EGR setpoints.

31. The product of claim 30 wherein the controller is further configured to initially establish the first and second EGR setpoints by multiplying a target total EGR flow setpoint by target first and second EGR contributions.

32. The product of claim 31 wherein the controller is further configured to determine the target total EGR flow setpoint on a basis of compliance with exhaust emissions criteria, and to determine the target first and second EGR contributions first on the basis of compliance with exhaust emissions criteria and then to optimize other criteria.

33. The product of claim 30 wherein the controller is further configured to:
apply a transfer function to the updated second EGR setpoint to produce a modified second EGR setpoint;
compare the second EGR setpoint to the modified second EGR setpoint; and
adjust the determined first and second EGR setpoints in response to the comparisons to generate adjusted first and second EGR setpoints.

34. The product of claim 33 wherein the transfer function is a dynamic compensation transfer function derived from a first transfer function associated with the first EGR path and a second transfer function associated with the second EGR path.

35. The product of claim 30 wherein the controller is further configured to associate the determined first and second EGR actuator commands with at least one of exhaust valve opening or closing percentages.

36. The product of claim 30, wherein the first and second EGR paths are high pressure (HP) and low pressure (LP) EGR paths.

37. The product of claim 36, wherein the HP EGR path is an internal HP EGR path in an engine of an engine system.

38. A product comprising:
a controller to control exhaust gas recirculation (EGR) and configured to:
establish base first and second EGR setpoints;
apply system constraints to the base first and second EGR setpoints to produce constrained first and second EGR setpoints;
determine first and second EGR actuator commands from the constrained first and second EGR setpoints;
determine updated first and second EGR setpoints corresponding to the determined first and second EGR actuator commands;
compare the base first EGR setpoint to the updated first EGR setpoint; and
adjust the base second EGR setpoint in response to the comparison to produce an adjusted second EGR setpoint.

39. The product of claim 38, wherein the system constraints include first and second EGR mass flow constraints.

40. A product comprising:
a controller to control exhaust gas recirculation (EGR) and configured to:
establish base HP and LP EGR setpoints, which are associated with HP and LP EGR paths and contribute to a total EGR setpoint;
apply system constraints to at least one of the established base HP and LP EGR setpoints or adjusted HP and LP EGR setpoints to produce constrained HP and LP EGR setpoints;
determine HP and LP EGR actuator commands corresponding to at least one of the established base HP and LP EGR setpoints, the constrained HP and LP EGR setpoints, or the adjusted HP and LP EGR setpoints;
apply respective actuator limits to the determined HP and LP EGR actuator commands to produce updated HP and LP EGR actuator commands;
determine updated HP and LP EGR setpoints corresponding to the updated HP and LP EGR actuator commands;
apply a transfer function to the updated LP EGR setpoint to produce a modified LP EGR setpoint;
compare the updated HP and modified LP EGR setpoints to the established base HP and LP EGR setpoints; and
adjust the base HP and LP EGR setpoints based on the comparison to generate the adjusted HP and LP EGR setpoints.

41. The product of claim 40 wherein the controller is further configured to establish the base HP and LP EGR setpoints by multiplying a target total EGR flow setpoint by target HP and LP EGR contributions.

42. The product of claim 41 wherein the controller is further configured to determine the target total EGR flow setpoint on a basis of compliance with exhaust emissions criteria and to determine the target HP and LP EGR contributions first on the basis of compliance with exhaust emissions criteria and then to optimize other criteria.

43. The product of claim 40 wherein the transfer function is a dynamic compensation transfer function derived from an HP transfer function associated with the HP EGR path and an LP transfer function associated with the LP EGR path.

44. The product of claim 40 wherein the HP and LP actuator commands are associated with at least one of exhaust valve opening or closing percentages.

45. The product of claim 40, wherein the HP EGR path is an internal HP EGR path in an engine.

46. The product of claim 40 wherein the HP EGR path is disposed on one side of a turbocharger between an engine and the turbocharger such that the HP EGR path is connected to an exhaust subsystem upstream of a turbine of the turbocharger and connected to an induction subsystem downstream of a compressor of the turbocharger, and the LP EGR path is disposed on another side of the turbocharger from the engine such that the LP EGR path is connected to the exhaust subsystem downstream of the turbocharger turbine and connected to the induction subsystem upstream of the turbocharger compressor.

47. A product comprising:
an intake throttle valve to control exhaust gas recirculation, and located downstream of an inlet end of an induction subsystem and upstream of a turbocharger compressor.

48. The product of claim 47, wherein the induction subsystem includes the intake throttle valve, a charge air cooler downstream of the turbocharger compressor, and an other intake throttle valve downstream of the charge air cooler.

49. The product of claim 48, further comprising:
an engine;
an exhaust subsystem to convey combustion gases away from the engine;
a turbocharger in communication across the exhaust and induction subsystems; and
an exhaust gas recirculation (EGR) subsystem across the exhaust and induction subsystems to recirculate exhaust gases for mixture with fresh air to improve emissions performance of the engine system, and having at least two EGR paths including a first EGR path, and a second EGR path connected to the induction subsystem downstream of the intake throttle valve.

50. The product of claim 49, wherein the first EGR path is disposed on one side of the turbocharger between the engine and the turbocharger such that the first EGR path is connected to the exhaust subsystem upstream of the turbocharger turbine but connected to the induction subsystem downstream of the turbocharger compressor, and wherein the second EGR path is disposed on the other side of the turbocharger from the engine such that the second EGR path is connected to the exhaust subsystem downstream of the turbocharger turbine but connected to the induction subsystem upstream of the turbocharger compressor.

51. The product of claim 50, wherein the first EGR path includes a first EGR valve to control recirculation of exhaust gases from the exhaust subsystem to the induction subsystem, wherein the first EGR path is connected upstream of the turbocharger turbine and downstream of the other intake throttle valve.

52. The product of claim 51, wherein the second EGR path includes a second EGR valve to control recirculation of exhaust gases from the exhaust subsystem to the induction subsystem, wherein the second EGR path is connected downstream of the turbocharger turbine and upstream of the turbocharger compressor to mix EGR gases with inlet air.

53. The product of claim 52, wherein the intake throttle valve is controlled to lower pressure in the induction subsystem and control EGR.
